(19) United States
(12) Patent Application Publication
(10) Pub. No.: US 2002/0118789 A1
(43) Pub. Date: Aug. 29, 2002

(54) Nuclear fuel assembly

(75) Inventor: John McCartney, Preston (GB)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: British Nuclear Fuels PLC

(21) Appl. No.: 10/122,570

(22) Filed: Apr. 15, 2002

Related U.S. Application Data
(63) Continuation of application No. 09/774,862, filed on Jan. 31, 2001, now abandoned.
Application No. 09/774,862 is a continuation of application No. 09/242,915, filed on May 14, 1999, now abandoned.

(30) Foreign Application Priority Data
Sep. 15, 1997 (GB) PCT/GB97/02485
Jan. 31, 2001 (GB) 9619182.0

(51) Int. Cl. G21C 3/30

(52) U.S. Cl. 376/428

(57) ABSTRACT

The invention is concerned with the minimization of radiological doses during manufacturing processes of fuel assemblies, by employing non-irradiated fuel as a shielding material against the radiological output of re-processed fuel materials. The non-irradiated fuel can be employed in peripheral fuel rods and/or in the end portions of fuel rods with beneficial effects.

### CROSS-REFERENCE TO RELATED APPLICATIONS

This application is a continuation of U.S. patent application Ser. No. 09/774,862, filed on Jan. 31, 2001, which is a continuation of U.S patent application Ser. No. 09/242,915, filed on May 14, 1999, which claims priority to International Application No. PCT/GB97/02485, filed Sep. 15, 1997, which claims priority to Great Britain Application No.9619182.0, filed Sep. 13, 1996, which applications are incorporated herein by specific reference.

### BACKGROUND OF THE INVENTION

1. The Field of the Invention

This invention concerns improvements in and relating to nuclear fuel assemblies, particularly with regard to further minimising radiological doses to fuel manufacturing plant, fuel transport facilities, and nuclear power plant personnel.

2. The Relevant Technology

A number of tasks concerning fuel rods and assemblies such as manufacturing, handling, loading, and inspection in the nuclear power industry call for close proximity of personnel to the fuel rod or fuel assembly. This is particularly true of the body extremities such as hands and eyes. Close inspection, visually or by touch is typically required, for instance in inspecting the completed fuel rods or finished fuel assemblies following completion of manufacturing operations or transportation, or prior to insertion into the reactor core. Close inspection of this type reduces the distance between personnel and the radioactive source and as a consequence the degree of attenuation of the dose is reduced.

Fuel for fuel rods for use in nuclear reactors falls into two basic categories, either virgin fuel from the primary extraction source which has been processed up to the required enrichment (so called non-irradiated uranium NIU) or alternatively reprocessed uranium (REPU) which has previously been in a reactor core and has subsequently been reprocessed prior to recycling it once more at the required reactivity equivalence.

Both NIU and REPU fuel materials are suitable for use as fuel, however, reprocessed fuel differs from non-irradiated fuel in that it contains minor components including irradiation induced isotopes of various materials (including, but not limited to, uranium isotopes and their related “daughter” products). These REPU components are significant from the radiological dose point of view, as they are of a higher spontaneous radioactivity than NIU of the corresponding grade.

### BRIEF SUMMARY OF THE INVENTION

The present invention, amongst other aims, aims to provide fuel assemblies which enable REPU to be used alongside NIU and yet significantly minimise the consequential radiological dose to personnel.

According to a first aspect of the invention we provide a nuclear fuel assembly comprising a plurality of fuel rods containing fuel wherein a proportion of the fuel in the fuel assembly is non-irradiated fuel and a proportion of the fuel in the fuel assembly is reprocessed fuel.

In this way the non-irradiated uranium (NIU) provides a shielding effect to the radiological output of the reprocessed uranium (REPU).

According to a second aspect of the invention we provide the use of a plurality of fuel rods containing non-irradiated fuel to shield against the radiological output of reprocessed fuel provided in the fuel assembly.

The first and/or second aspects of the invention may further provide the following possibilities.

Optionally the NIU fuel maybe provided at or close to the periphery of the fuel assembly.

The NIU fuel or a substantial part of it may be provided in the edge fuel rods or those fuel rods adjacent to the peripheral rods of the assembly.

The REPU fuel may be provided internally within the fuel assembly. For instance the REPU fuel may be provided in non-peripheral fuel rods.

Preferably the NIU is provided as a discrete portion of the fuel in a given fuel rod relative to REPU fuel. The discrete portion may be formed of fuel pellets.

Preferably one or more of the fuel rods are provided with NIU fuel in one or both end portions of the fuel pellet stack. Preferably the rods are provided with NIU fuel only in such end portions.

Preferably the NIU end portions represent between 1 and 15% and most preferably between 3 and 10%, of the length of fuel pellet stack in the fuel rod. A similar or dissimilar length NIU portion may be provided at the other end of the given fuel rod. The REPU may therefore constitute between 98 and 70% or between 94 and 80% respectively of the fuel in a given fuel rod.

A shielding effect may be obtained with more than 40% of the fuel rods in an assembly being provided with one or both NIU end portions. Preferably the level is in excess of 70%, more preferably 80% and ideally in excess of 90%. Provision of all the fuel rods with such NIU end portions is highly desirable, but a partial screening effect can be obtained even where some lack the NIU end portion.

Preferably a number of the peripheral fuel rods of the assembly are provided with NIU throughout all, or a substantial portion, of their length. Most preferably such peripheral fuel rods are provided with NIU fuel only.

Most preferably all of the peripheral fuel rods are provided with NIU, but a screening effect can be obtained with more than 90%, more than 80%, more than 70% and even with 40% or more of the fuel rods being provided with NIU.

The NIU may be mixed with REPU and still reduce the radiological dose or the NIU may be provided as a cylindrical coating or layer around a REPU core in the fuel rod or pellets. For simplicity sake the use of NIU alone is however preferred.

In a particularly preferred embodiment of the invention all or substantially all of the peripheral fuel rods in a fuel assembly are provided with NIU fuel only and all or substantially all of the fuel rods have their end portion of fuel provided as NIU fuel. The non-peripheral fuel in such an assembly is preferably REPU or includes REPU.

The fuel assembly may be of the types suitable for use in light water reactors (including boiling water reactors and pressurised water reactors), advanced gas cooled reactors, VVER or CANDU types, graphite moderated reactors (including RBMK or Magnox), advanced thermal reactors and fast-reactor types (including radial blanket fuel).

For example in an AGR fuel assembly between 9 and 18 and preferably all 18 of the peripheral fuel rods may be provided with NIU; for a CANDU fuel bundle between 9 and 18 and preferably all 18 of the peripheral fuel rods may once again be provided with NIU; for a new 43 pin CANDU fuel bundle between 10 and 21 and preferably all 21 peripheral fuel rods maybe NIU; for a VVER-440 fuel assembly between 18 and 36 and preferably all 36 peripheral fuel rods are provided with NIU; for a BWR fuel assembly with for example, a 9×9 fuel rod array between 16 and 32 and preferably all 32 of the fuel rods may be provided with NIU.

The fuel enrichment between individual rods and between portions of a given rod may vary. Peripheral rods may be provided with a lower fuel enrichment than internal fuel rods. The end portions of fuel rods may be provided at a lower enrichment than the middle portions of fuel rods.

According to a third aspect of the invention we provide a nuclear fuel rod containing NIU fuel and REPU fuel.

Preferably the NIU fuel is provided at one or both ends of the fuel rod. Most preferably the NIU fuel is provided in a discrete portion. The NIU maybe provided as a substack of pellets adjacent to or in conjunction with REPU pellets.

Preferably the NIU fuel portion comprises between 1 and 15% and most preferably between 3 and 10% of the total fuel stack within the fuel rod. A similar or different length portion may be provided at the alternate end of the fuel rod.

According to a fourth aspect of the invention we provide the use of a nuclear fuel rod containing NIU fuel together with (i) REPU fuel and/or with (ii) one or more further fuel rods containing REPU fuel.

Preferably the NIU-containing fuel rod is provided peripherally relative to the REPU fuel rod in use.

According to a fifth aspect of the invention we provide a reactor core incorporating one or more fuel assemblies according to the first aspect of the invention and/or one or more fuel rods according to the second aspect of the invention.

According to a sixth aspect of the invention we provide a method of producing a nuclear fuel assembly comprising a plurality of fuel rods containing fuel, in which the fuel comprises both REPU and NIU fuel.

Preferably the method provides a first fuel rod type in the assembly, the fuel rod having a NIU fuel portion at one or both ends of the fuel in the rod, the remaining fuel comprising REPU fuel.

Alternatively or additionally a second fuel rod type maybe provided in the assembly, the second type fuel rod having NIU fuel throughout all or a substantial part of its length, at least some of the second fuel rod type being provided at or close to the periphery of the assembly with other fuel rods containing REPU.

According to a seventh aspect of the invention we provide a method of fuelling or re-fuelling a nuclear reactor core comprising providing one or more fuel assemblies according to the first aspect of the invention and/or incorporating a fuel rod according to the second aspect of the invention and/or produced according to the method of the fifth aspect of the invention in the reactor core.

According to a eighth aspect of the invention we provide electricity generated by a nuclear power station using any of the first to sixth aspects of the invention.

These and other objects and features of the present invention will become more fully apparent from the following description and appended claims, or may be learned by the practice of the invention as set forth hereinafter.

### BRIEF DESCRIPTION OF THE DRAWINGS

In order that the manner in which the above recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a plan view of a fuel assembly according to a first embodiment of the invention;

FIG. 2 illustrates a perspective view of a fuel assembly according to a second aspect of the invention;

FIG. 3 illustrates a perspective view of a fuel assembly according to a third aspect of the invention; and

FIGS. 4A-4D illustrates embodiments of the invention employed in BWR, AGR, VVER and CANDU fuel assembly types.

### DETAILED DESCRIPTION OF THE PREFERRED EMBODIMENTS

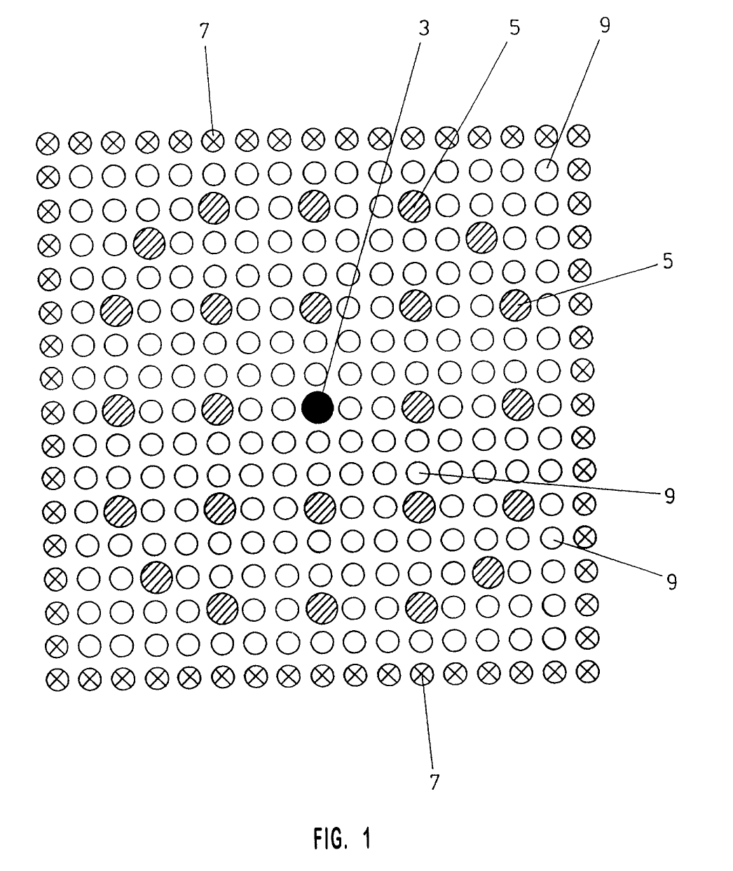

FIG. 1 shows in plan view the fuel rod array for a fuel assembly according to the invention. The central tube (3) is capable of retaining in-core neutron flux detection or similar instrumentation as required. The (diagonally hatched) tubes (5) correspond to guide thimbles designed to accommodate neutron absorbing reactor control rods upon insertion. Around the periphery of the assembly (crossed) fuel rods (7) are provided, with the remainder of the fuel assembly being made up of (plain) fuel rods (9).

The first type of fuel rod, (7), is made up on non-irradiated (NIU) or so-called virgin fuel. This fuel represents a lower radiologically active material than the second type of fuel (9) which is made up of reprocessed fuel, REPU. REPU may of course include other components than uranium, for instance plutonium. REPU fuel rods may be MOX fuel rods. By providing the NIU fuel in fuel rods around the perimeter of the assembly the fuel assembly is given a self-shielding capacity. The NIU rods (7) serve to attenuate the radiological activity of the REPU fuel rods (9). As a consequence radiological dose per unit of time given by the REPU fuel rods to an operator coming into proximity with the exterior of the fuel assembly is further reduced. In this first embodiment NIU fuel is provided in the fuel rods around the periphery of the assembly only.

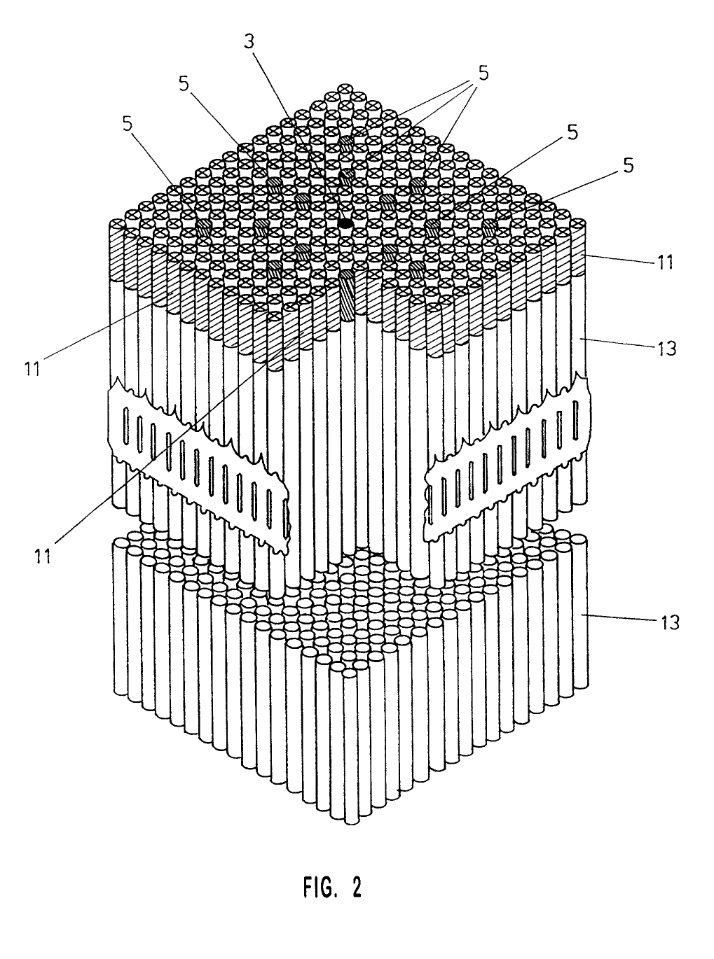

An alternative embodiment of the invention is shown in perspective in FIG. 2. Here the fuel rod assembly is shown with a portion at the near front corner of the fuel assembly removed. Once again instrument tube (3) and control guide thimbles (5) are provided. In this embodiment the fuel rods are all of the same type but have distinct portions within them. At the end face a portion of the fuel rod pellet stack is provided from a number of discrete pellets (11) formed from NIU fuel. A similar portion may be provided at the other end of the fuel rods. The remainder of the length of the fuel rod is however formed from REPU fuel in pellet form. In this structure the NIU provides a shielding effect to the radiological dose emanating from the end faces of the fuel assembly.

The present invention offers a significant benefit in situations where multiple fuel assemblies are employed in a reactor channel. By using fuel assemblies provided with NIU fuel in the extremity positions in the channel the screening effect reduces operator extremity dose during completion of total (multi-element) final assembly operations prior to reactor loading. Such a situation applies to AGR fuel stringers for instance.

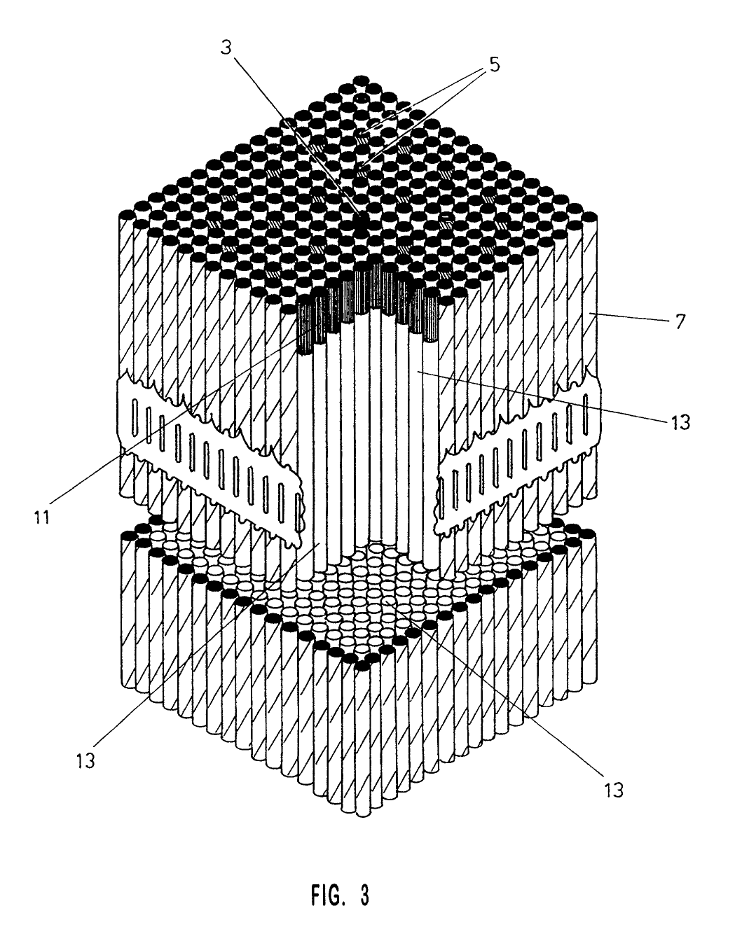

In a further refinement, the embodiment of FIG. 3, the instrument and control rod guide thimbles are provided in the same locations as before. However, in this embodiment the peripheral rods (7) consist throughout their length of NIU fuel. In addition the nonperipheral fuel rods are provided with a NIU portion (11) at their ends, in a similar manner to FIG. 2, with REPU fuel being provided in portions (13) covering most of their lengths. A fuel assembly according to this embodiment is thus shielded from top, bottom and all sides, thus reducing the radiological dose given by the REPU in all directions.

Whilst the above examples demonstrate the use of the invention in PWR fuel rods and/or assemblies the invention is equally applicable in other nuclear fuel assembly types.

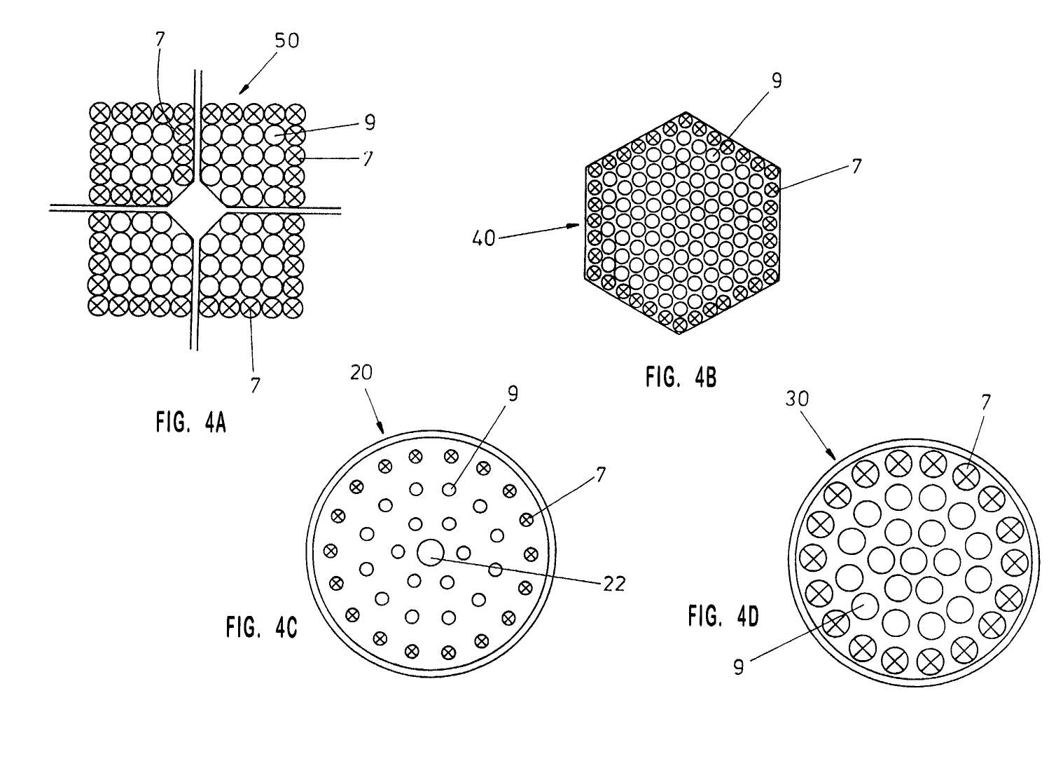

FIGS. 4A-4D illustrate the use of the invention in an AGR assembly (20) with guide tube (22); CANDU assembly (30); VVER or fast reactor radial blanket (40) and BWR assembly (50). In each case, by providing some or all of the peripheral rods as NIU fuel the assembly is given a self-shielding capacity against the potential operator radiological dose arising from the REPU fuel (9). In each case the assembly can be provided with end screening as exemplified in FIG. 2, side screening as exemplified in FIG. 1 or both side and end screening as exemplified in FIG. 3.

Whilst achieving the self-shielding effect discussed above the performance of the fuel assemblies remains unaltered as the equivalent reactivity of the NIU or REPU fuel is not necessarily varied. It is the distinction between the disposition of NIU and REPU material within the fuel rods and within the assembly which is used in achieving the effect of the invention, not the material enrichment.

If desired the enrichment of fuel in any given rod or any given portion of a rod can be varied as required to give the desired reactivity/assembly peak power rating etc, with the fuel source NIU or REPU being selected to give shielding or not depending on the rods position within the assembly.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A nuclear fuel assembly comprising a plurality of fuel rods having opposing ends and containing nuclear fuel, the plurality of fuel rods including peripheral fuel rods wherein the nuclear fuel within at least 40% of the peripheral fuel rods is comprised of non-irradiated fuel, the non-irradiated fuel being disposed along at least a majority of the length of each of the at least 40% of the peripheral fuel rods, and wherein the nuclear fuel within at least one of the opposing ends of at least 40% of the plurality of fuel rods is comprised of non-irradiated fuel, at least some of the plurality of fuel rods wherein at least one of the opposing ends is comprised of non-irradiated fuel having re-processed fuel disposed between the opposing ends thereof.

2. A fuel assembly according to claim 1 in which at least 70% of the peripheral fuel rods are provided with non-irradiated uranium.

3. A fuel assembly according to claim 1 in which more than 70% of the fuel rods in the assembly are provided with one or both end portions of non-irradiated uranium.

4. A fuel assembly according to claim 1 in which peripheral fuel rods provided with non-irradiated uranium are provided with non-irradiated uranium fuel only.

5. A fuel assembly according to claim 1 in which the fuel assembly is selected from the group consisting of an AGR fuel assembly, CANDU assembly, VVER fuel assembly, and BWR fuel assembly.

6. A method of producing a nuclear fuel assembly having nuclear fuels rods, the method comprising:
introducing first fuel rod types into the assembly such that the first fuel rod types comprise at least 40% of the fuel rods, the first fuel rod types having opposing ends and containing nuclear fuel, the nuclear fuel within the first fuel rod types being comprised of re-processed fuel with non-irradiated fuel being positioned within at least one of the opposing ends thereof; and
introducing second fuel rod types into the assembly such that the second fuel rod types comprise at least 40% of the fuel rods at the periphery of the assembly, the second fuel rod types containing non-irradiated fuel along at least a majority of their length.

7. A nuclear fuel assembly including a plurality of fuel rods having opposing ends and containing nuclear fuel, the plurality of fuel rods including peripheral fuel rods and non-peripheral fuel rods, the nuclear fuel within at least 80% of the peripheral fuel rods being provided throughout with non-irradiated fuel, the nuclear fuel within both of the opposing ends of at least 80% of the plurality of fuel rods being comprised of non-irradiated fuel, a portion of the nuclear fuel within the non-peripheral fuel rods being comprised of reprocessed fuel.

8. A nuclear fuel assembly including a plurality of fuel rods having opposing ends and containing nuclear fuel, the plurality of fuel rods including peripheral fuel rods and non-peripheral fuel rods, the nuclear fuel within the peripheral fuel rods consisting of non-irradiated fuel, the nuclear fuel within both of the opposing ends of the non-peripheral fuel rods consisting of non-irradiated fuel, at least some of the nuclear fuel between the opposing ends of the non-peripheral fuel rods including re-processed fuel.
